(19) United States
(12) Patent Application Publication
(10) Pub. No.: US 2012/0050445 A1
(43) Pub. Date: Mar. 1, 2012

(54) PRINTER, ROLL AND METHOD FOR USE OF THE SAME

(75) Inventor: Hiroshi Minakuchi, Shizuoka (JP)

(73) Assignee: TOSHIBA TEC KABUSHIKI KAISHA, Tokyo (JP)

(21) Appl. No.: 13/216,405

(22) Filed: Aug. 24, 2011

(30) Foreign Application Priority Data
Aug. 25, 2010 (JP) 2010-187775

(51) Int. Cl. B41J 2/325

(52) U.S. Cl. 347/171

(57) ABSTRACT

According to one embodiment, a printer includes a roll supporting unit configured to rotatably support a roll including a hub having a light reflection changing member and a strip-shaped material wound around the hub, a sensor unit configured to irradiate light toward the light reflection changing member and receive reflected light from the light reflection changing member, and a determination unit configured to determine identification information for identifying the roll based on the reflected light received by the sensor unit. The printer further includes a control unit configured to set a print condition based on the identification information determined by the determination unit, and a print unit configured to print on the strip-shaped material based on the print condition set by the control unit.

### CROSS-REFERENCE TO RELATED APPLICATION

This application is based upon and claims the benefit of priority from Japanese Patent Application No. 2010-187775, filed on Aug. 25, 2010, the entire contents of which are incorporated herein by reference.

### FIELD

Embodiments described herein relate generally to a printer, a roll and a method for use in the printer.

### BACKGROUND

A printer of the related art may be configured to hold a strip-shaped ink ribbon and a strip-shaped print medium, each being wound into a roll shape, and to print information on the print medium. Various ink ribbons and target print media may be used in such a printer, each of which may have specific material properties. For example, an ink ribbon may have high heat resistance and high abrasion resistance. Further, a print medium may have high or low durability (or rigidity) depending on implementation.

In order to ensure print quality, print conditions required for the printer (e.g., heat energy required to be applied to a thermal head varying with a supply time of a current supplied to the thermal head, a voltage potential applied to the thermal head, or the like) need to be set by taking into consideration the material properties of the ink ribbon and the print medium.

Since a variety of kinds of ink ribbons and target print media may be selectable to be used in the printer, an operator has to set print conditions, e.g., heat energy required to be applied to a thermal head, based on the kind of selected ink ribbon, the kind of selected print medium or the combination of the kinds of selected ink ribbon and print medium, each time the operator uses the printer or changes at least one of the kinds of ink ribbon and print medium. However, such operations for setting the print conditions may be considerably complicated and time-consuming for the operator to perform.

### BRIEF DESCRIPTION OF THE DRAWINGS

FIG. 1 is a view showing an internal configuration of a printer.

FIG. 2 is a functional block diagram of the printer.

FIG. 3A is a view illustrating an exterior appearance of a roll (of a target print medium or an ink ribbon).

FIG. 3B is a view describing a hub of the roll.

FIG. 4 is a development view of the hub of the roll.

FIG. 5 depicts a waveform derived from the hub of the roll.

FIG. 6 is a print condition table that stores respective print conditions for target print media and ink ribbons.

FIG. 7 is a view showing an exterior appearance of a roll (of a target print medium) when held by a roll supporting unit.

FIG. 8 is a view illustrating an exterior appearance of a roll (of an ink ribbon) when held by a roll supporting unit.

FIG. 9 is a flowchart for setting print conditions.

### DETAILED DESCRIPTION

According to one embodiment, a printer includes a roll supporting unit configured to rotatably support a roll including a hub having a light reflection changing member and a strip-shaped material wound around the hub, a sensor unit configured to irradiate light toward the light reflection changing member and receive reflected light from the light reflection changing member, and a determination unit configured to determine identification information for identifying the roll based on the reflected light received by the sensor unit. The printer further includes a control unit configured to set a print condition based on the identification information determined by the determination unit, and a print unit configured to print on the strip-shaped material based on the print condition set by the control unit.

Embodiments will now be described in detail with reference to the drawings. In the present disclosure, a thermal transfer type printer that performs a print operation on a print surface of a label paper (used as a target print medium) by thermally transferring ink from an ink ribbon to the label paper by means of a thermal head having a plurality of heating elements will be presented by way of example. However, embodiments described below are not intended to be limited thereto, but may employ other types of printers, e.g., a printer of the type in which a thermal head is configured to print on a thermal paper without an ink ribbon.

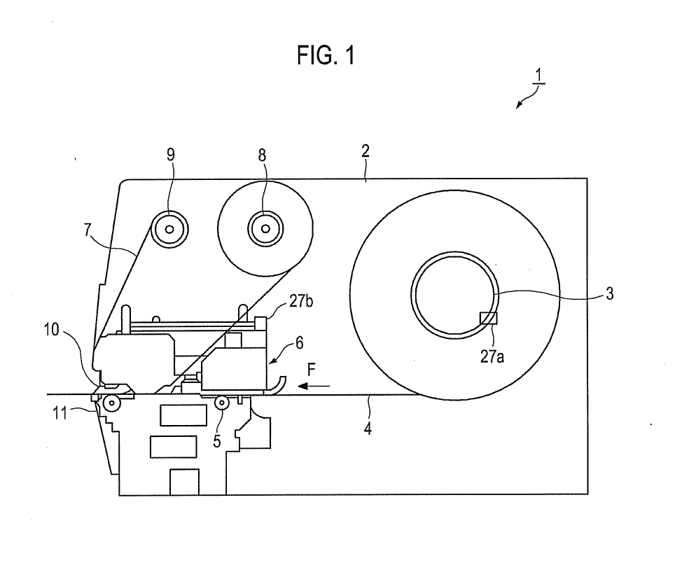

FIG. 1 is a view showing an internal configuration of a printer. The printer 1 shown in FIG. 1 includes a housing 2. Arranged within the housing 2 are a paper supporting shaft 3 for supporting a roll including a hub (formed of, e.g., a paper pipe) and a strip-shaped target print medium 4 (e.g., a label paper) that is wound around the hub and is dischargeable (i.e., unwound) from the hub, a supply shaft 8 for supporting a roll including a hub and a strip-shaped ink ribbon 7 that is wound around the hub and is dischargeable therefrom, a take-up shaft 9 for winding the ink ribbon 7 thereon, which is discharged from the supply shaft 8, a pair of sensor units 27a and 27b, a conveying mechanism and a print unit. In the present disclosure, the paper supporting shaft 3 and the supply shaft 8 may be collectively referred to as a roll supporting unit.

The paper supporting shaft 3 rotatably supports the roll of the target print medium 4 (e.g., a label paper) so that the target print medium 4 can be fed to a thermal head 10 serving as the print unit. The target print medium 4 is a strip-shaped paper and may be either a label paper formed of a liner (i.e., backing sheet) and a label attached on the liner, or a so-called liner-less label formed without a liner.

The target print medium 4 (e.g., a label paper) fed from the paper supporting shaft 3 is conveyed to the print unit (which will be describe later in detail) by the conveying mechanism.

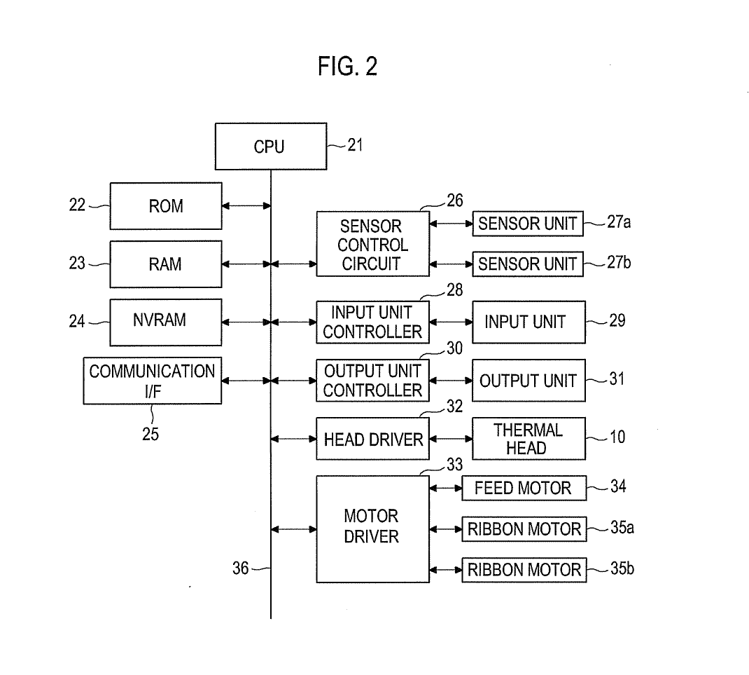

A conveying roller 5 and a platen roller 11 are driven to rotate by a motor (see FIG. 2) or other drive units. The conveying roller 5 is arranged at the upstream side of the thermal head 10 and the platen roller 11. A pinch roller block 6 includes a pinch roller arranged above and in the vicinity of the conveying roller 5 and also in parallel with the conveying roller 5. The pinch roller is biased toward the conveying roller 5 with a suitable pressing force. The target print medium 4 is held between the conveying roller 5 and the pinch roller and is conveyed in conjunction with the rotation of the conveying roller 5. The conveying roller 5, the platen roller 11, the motor and the pinch roller block 6 make up the conveying mechanism. An arrow F shown in FIG. 1 indicates a conveying direction in which the target print medium 4 is conveyed.

The supply shaft 8 supports the roll of the ink ribbon 7, which is dischargeable from the supply shaft 8. The roll of the ink ribbon 7 held by the supply shaft 8 includes a hub formed of, e.g., a paper pipe, and a strip-shaped ink ribbon 7 wound around the hub. If the take-up shaft 9 is rotated by the motor, the ink ribbon 7 is drawn from the roll of the ink ribbon 7 held on the supply shaft 8. The ink ribbon 7 drawn from the supply shaft 8 is held between the thermal head 10 (which will be described later in detail) and the platen roller 11 together with the target print medium 4. If heating elements of the thermal head 10 emit heat, the ink of the ink ribbon 7 is dissolved or sublimated to thereby perform printing on the target print medium 4.

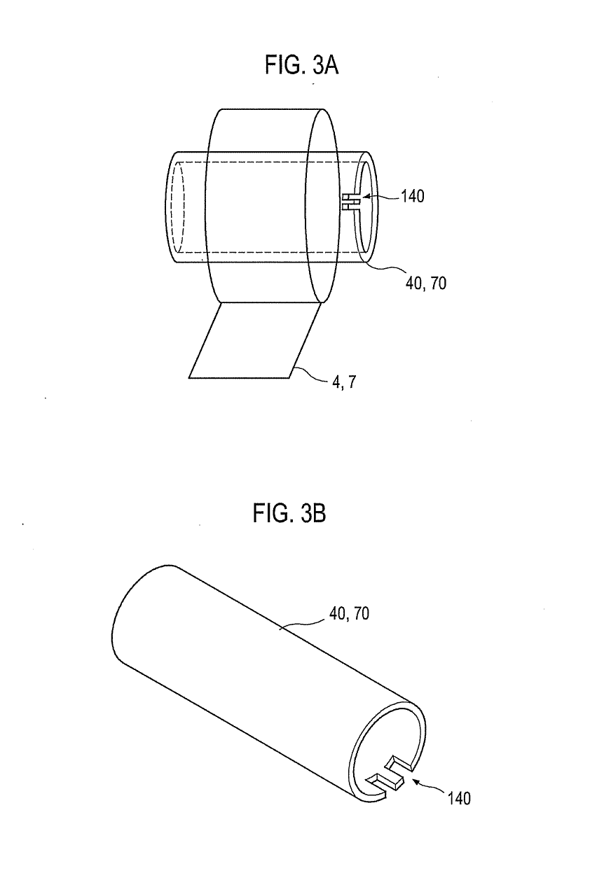

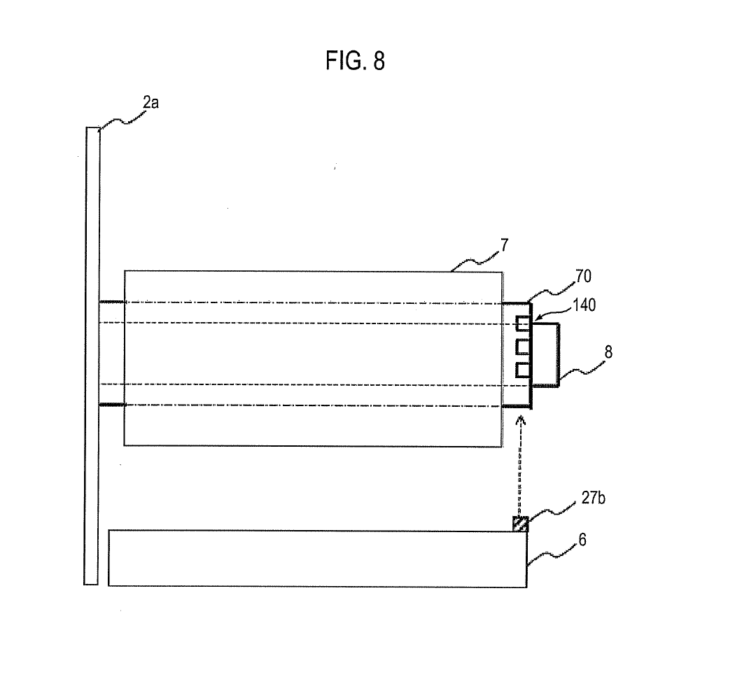

The sensor units 27a and 27b may be optical sensors and configured to irradiate light toward a particular portion of the rolls loaded to the paper supporting shaft 3 and the supply shaft 8 and to detect the light reflected from the particular portion of the rolls. In one embodiment, a light reflection changing member may be formed on a particular portion of the rolls. The light reflection changing member may include, but not limited to, slits 140 (illustrated in FIGS. 3A and 3B) with a particular pattern formed on, for example, end portions (i.e., edge portions) of the hubs of the rolls. The target print medium 4 and the ink ribbon 7 are not wound on the end portions so that the end portions (specifically, the slits 140 formed thereon) are not covered by the target print medium 4 and the ink ribbon 7 and can be illuminated by lights irradiated by the sensor units 27a and 27b. The sensor unit 27a is attached to the housing 2 of the printer 1. Alternatively, the sensor unit 27a may be attached to a paper guide (which will be described later in detail) for restraining movement of the roll (see FIGS. 1 and 8). The sensor unit 27a may be embedded in the paper supporting shaft 3 in such a fashion as to irradiate light toward the hub end portion of the roll. The sensor unit 27b is configured to irradiate light toward the roll loaded to the supply shaft 8. The sensor unit 27b may be provided either at the upper portion of the pinch roller block 6 or at the upper portion of the print unit having the thermal head 10. In other words, either the sensor unit 27a or 27b may be placed at a certain position where each sensor unit can detect either one of the hub end portions of the rolls. The sensor units 27a and 27b respectively include, e.g., reflection type sensors each having a light-emitting element and a light-receiving element.

As shown in FIG. 2, the control circuit of the printer 1 includes a CPU (Central Processing Unit) 21, a ROM (Read Only Memory) 22, a RAM (Random Access Memory) 23, an NVRAM (Non-Volatile RAM) 24, a communication interface (I/F) 25, a sensor control circuit 26, sensor units 27a and 27b, an input unit controller 28, an input unit 29, an output unit controller 30, an output unit 31, a head driver 32, a thermal head 10, a motor driver 33, a feed motor 34 and ribbon motor (which may include a first ribbon motor 35a and a second ribbon motor 35b), which are connected to each other through a bus 36 such as an address bus or a data bus. The motor driver 33 can supply the CPU 21 with the operation data received from the feed motor 34 and the ribbon motor.

The CPU 21 controls respective parts of the printer 1 by executing various kinds of computer-readable programs stored in the ROM 22 and so forth. In the present disclosure, the CPU 21 may be referred to as a control unit. The ROM 22 stores, e.g., various kinds of data and various kinds of programs executable by the CPU 21, such as a BIOS (Basic Input Output System) program, an application program and a device driver program. The RAM 23 temporarily stores data and programs when the CPU 21 executes various kinds of programs. The NVRAM 24 stores, e.g., an operating system, an application program, a device driver program and various kinds of other data that need to be maintained even when the power of, e.g., the printer 1 is off.

The communication interface (I/F) 25 controls data communication with other devices (e.g., a host PC) connected through electric communication lines.

The sensor control circuit 26 is connected to the sensor units 27a and 27b and controls the operations of the sensor units 27a and 27b. In response to an instruction from the CPU 21, the sensor control circuit 26 controls the sensor units 27a and 27b to irradiate light toward an irradiation target, such as an area including the hub end portion of a roll in this embodiment, and to receive the light reflected from the irradiation target with a light-receiving element.

In response to an instruction from the CPU 21, the output unit controller 30 controls the output unit 31 (e.g., a display unit, a light emitting unit, a speaker, a buzzer or the like) to output therethrough an image, sound or the like. The input unit controller 28 controls the input unit 29 (e.g., a push button, a touch panel, a keyboard, a microphone, a knob, a DIP switch or the like) to input therethrough a user's manual operation, sound or the like.

The head driver 32 controls the thermal head 10 in response to an instruction from the CPU 21.

In response to an instruction from the CPU 21, the motor driver 33 controls the feed motor 34 and the ribbon motor to rotate, both of which may include, e.g., stepping motors.

FIG. 3A is a view showing a roll employed in the present embodiment. The strip-shaped material wound around a hub 40 or 70 may be either the target print medium 4 or the ink ribbon 7. FIG. 3B is a view showing a hub of the roll of the present embodiment, on which a strip-shaped material is to be wound (hereinafter, the hub for the target print medium 4 will be referred to as a hub 40 and the hub for the ink ribbon 7 will be referred to as a hub 70). The hub 40 or 70 is made of, e.g., paper. The roll of the target print medium 4 is held by the paper supporting shaft 3 and the roll of the ink ribbon 7 is held by the supply shaft 8. In other words, the rolls of the target print medium 4 and the ink ribbon 7 are held by a roll supporting unit.

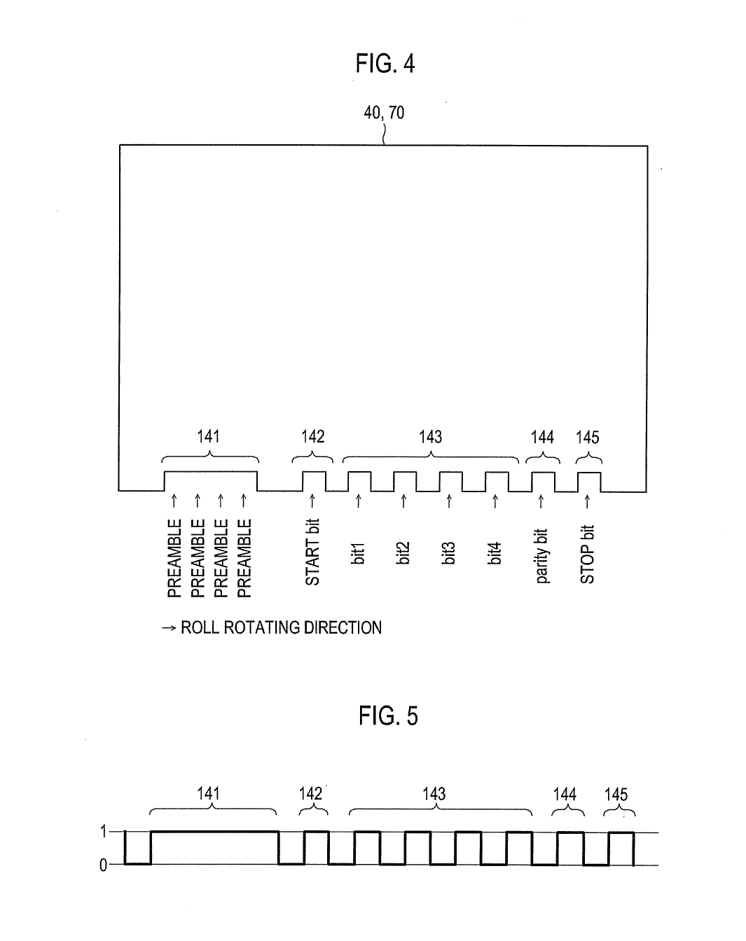

FIG. 4 is a development view showing the hub 40 or 70 formed of, e.g., a paper pipe. As shown in FIG. 4, a plurality of slits 140 each having a cutout shape is formed on the end portion of the hub 40 or 70. The slits 140 include a preamble portion 141, a start bit portion 142, a data bit portion 143, a parity bit portion 144, and a stop bit portion 145.

The preamble portion 141 is used to indicate an initial position of subsequent data and serves to synchronize signals, e.g., for controlling irradiating light toward the slits 140 and detecting the light reflected from the slits 140. The start bit portion 142 is provided as an indicator of the start of data appearing after the start bit portion 142. The data bit portion 143 is formed of a data series including, but not limited to, four bits, e.g., bit 1, bit 2, bit 3 and bit 4. In FIG. 4, a single slit in the bit portion 143 defined by one cutout represents a single bit.

The parity bit portion 144 is a bit provided for detecting an error. The stop bit portion 145 is bit information provided as an indicator of a bit showing an end position of the data.

As mentioned above, the slits 140 provided in the hub end portions of the rolls of the target print medium 4 and the ink ribbon 7 are formed in an unique (e.g., distinguishable) shape for a particular kind of roll used in the printer 1, so that the shape of the slits 140 can be used as identification information for the particular kind of roll. In other words, the shapes of the slits 140 may be formed based on a particular pattern that corresponds to a particular roll.

Specifically, the bit array information read from the slits 140 of the data bit portion 143 may be matched with the identification information of a particular kind of roll, e.g., of the target print medium 4, on a one-to-one basis. For example, if the bit array information of the data bit portion 143 reads [0001], the roll of the target print medium 4 may be identified as a particular kind of a label paper. Such bit array information [0001] may be obtained by converting an analog signal received by the sensor unit 27a to a digital signal with an analog-to-digital converter. As used herein, the identification information may include specific information for specifying the kind of the target print medium 4 and may represent the name of the target print medium 4 (e.g., label paper A, label paper B, etc.). The identification information is not limited to the name of the target print medium 4 but may include attribute information such as a seller name, a manufacturer name, a model number, a stock number, a product code, specifications (e.g., width, length and thickness), a manufacturing location and a manufacturing date. That is to say, the identification information serves as information for distinguishing one roll from another.

In the case of the roll of the ink ribbon 7, the bit array information read from the data bit portion 143 of the slits 140 formed at the hub 70 may be matched with the identification information of the ink ribbon 7 on a one-to-one basis.

FIG. 5 shows a waveform of an output signal obtained from the sensor unit 27a or 27b receiving reflection light after it irradiates light toward the roll of the target print medium 4 or the ink ribbon 7 rotating at a specific rotation speed, which is driven by a drive unit (e.g., the feed motor 34 or the ribbon motor). FIG. 5 illustrates a case where the bit array information of the data bit portion 143 obtained by A/D conversion of the output signal reads [1111]. The waveform shown in FIG. 5 represents the signal waveform which is derived from the slits 140 of the hub 40 or 70 shown in FIG. 4. Since the reflection light reflected from the slit area (i.e., the cut-out area) of the hub end portion and the reflection light reflected from the non-slit area (i.e., the non-cut-out area) of the hub end portion show a difference in light reflection amount (or intensity), the derived waveform varies with the shape of the slits 140 (see FIG. 5).

The rotation speed of the roll mounted on the roll supporting unit may not be the same each time the printer 1 is used. For this reason, the operation of reading the bit array information of the data bit portion 143 may be performed in the following manner. For example, a bit length for a single bit is determined based on the detected bit length of the preamble portion 141 when the roll rotates substantially at a constant speed. Once the bit length of a single bit is determined in this manner, the bit array information corresponding to the data bit portion 143 is read based on the determined bit length of a single bit.

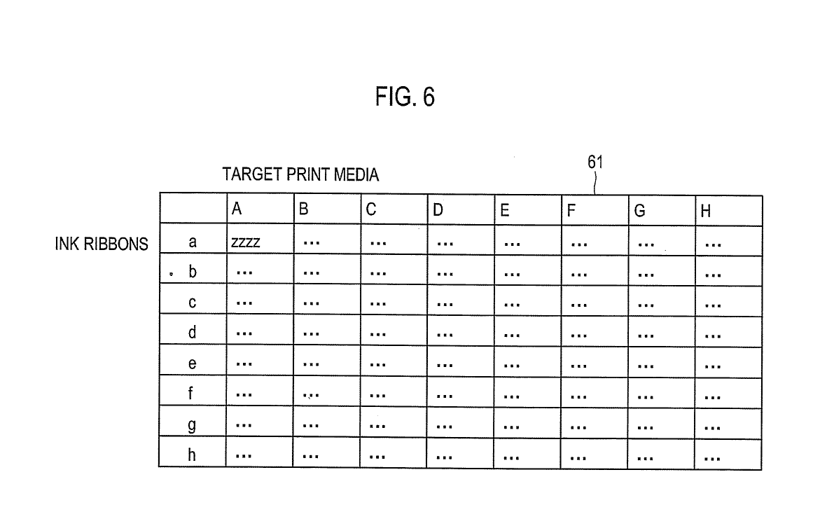

For respective combinations of the ink ribbon 7 and the target print medium 4 that are available for use in the printer 1, the storage unit stores the thermal energy amount required to be applied to the thermal head 10 in a print condition table 61 (e.g., in a format as shown in FIG. 6). For example, the storage unit stores the optimal value of the thermal energy amount required to be applied to the thermal head 10 to achieve an acceptable print quality for a particular combination of the ink ribbon “a” and the label paper “A.” The print conditions provided for the respective combinations of the ink ribbon 7 and the target print medium 4, which are stored in the storage unit, are not limited to the thermal energy amount to be applied to the thermal head 10, but may include, e.g., a current supply time for generating the thermal energy suitable for the respective combinations of the ink ribbon 7 and the target print medium 4. In the present disclosure, the NVRAM 24 may be referred to as the storage unit.

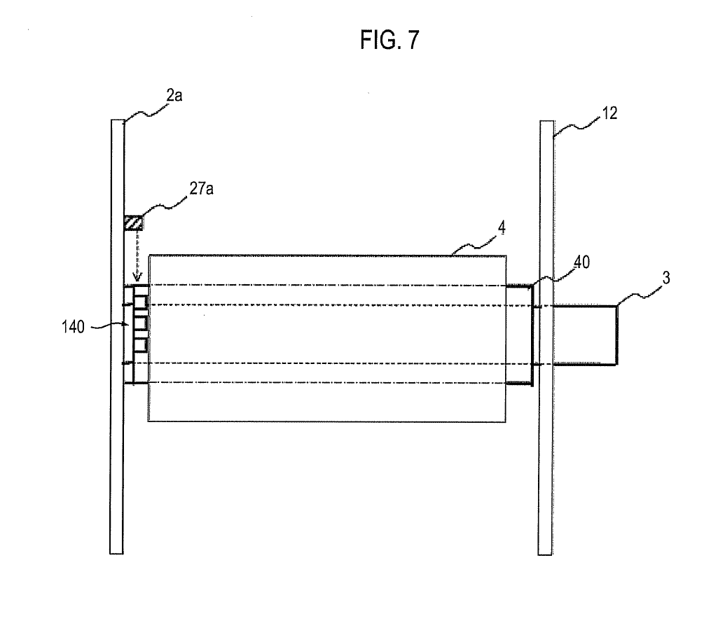

FIG. 7 shows a configuration where the roll of the target print medium 4 (e.g., a label paper) is loaded to the paper supporting shaft 3. As shown, the roll of the target print medium 4 is mounted around the paper supporting shaft 3. The roll of the target print medium 4 is so loaded that the hub end portion having the slits 140 can be placed close to a wall surface 2a of the housing 2. A reflection type sensor irradiates light toward the hub end portion of the roll of the target print medium 4 and in turn obtains a signal waveform therefrom. Identification information of the roll of the target print medium 4 may be obtained based on the signal waveform. A paper guide 12 for restraining the movement of the roll of the target print medium 4 in the width direction thereof may be mounted to the paper supporting shaft 3.

In another embodiment of the present disclosure, the reflection type sensor used as the sensor unit 27a may be attached to the paper guide 12. In this case, the roll is mounted so that the hub end portion having the slits 140 can be positioned close to the paper guide 12.

The following is a description on the roll of the ink ribbon 7 loaded to the supply shaft 8 and the positional relationship of the sensor unit 27b with the roll of the ink ribbon 7 with reference to FIG. 8. The roll of the ink ribbon 7 is so loaded that the hub end portion having the slits 140 can be placed remote from the wall surface 2a of the housing 2. The roll of the ink ribbon 7 mounted on the supply shaft 8 rotates substantially at a constant speed in synchronization with the ink ribbon winding operation of the take-up shaft 9. While the roll of the ink ribbon 7 rotates substantially at a constant speed, the sensor unit 27b irradiates light toward an area including the hub end portion of the roll and reads identification information from the signal waveform detected by the reflection type sensor thereof. In the example shown in FIG. 8, the sensor unit 27b is provided in the upper portion of the pinch roller block 6 having a pinch roller. Alternatively, the reflection type sensor used as the sensor unit 27b may be attached to the supply shaft 8.

In the sensor unit 27a or 27b, the light-emitting element and the light-receiving element may be integrated as a single unit or provided independently of each other. In other words, the sensor unit 27a or 27b may be implemented in any configuration as long as it is capable of detecting identification information by irradiating light toward the slits 140 formed on the end portion of the hub 40 or 70.

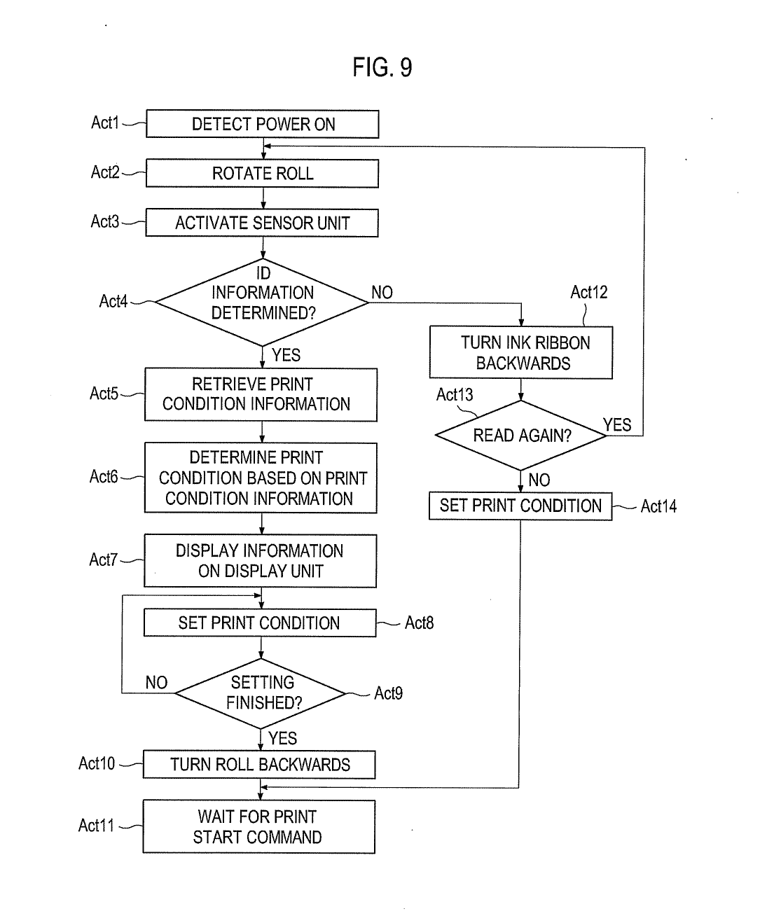

The operation of setting the print conditions according to one embodiment will be described with reference to FIG. 9. First, the printer 1 is started up if the CPU 21 detects that the electric power of, e.g., the printer 1 is switched on (Act 1). In the initial startup operation, the printer 1 conveys (or draws) the target print medium 4 (e.g., a label paper) to thereby rotate the roll of the target print medium 4, mounted to the paper supporting shaft 3 (Act 2). Specifically, the conveying roller 5 is driven by the feed motor 34 is to be rotated to thereby convey the target print medium 4, rotating the roll of the target print medium 4 in conjunction therewith.

Meanwhile, the printer 1 operates the ribbon motor to rotate the roll of the ink ribbon 7 mounted on the supply shaft 8 (Act 2). Specifically, the ink ribbon 7 being discharged from the roll of the ink ribbon 7 held by the supply shaft 8 is moved between the thermal head 10 and the platen roller and is again wound around the take-up shaft 9. Therefore, if the take-up shaft 9 is driven by the ribbon motor to be rotated at a constant speed, the roll of the ink ribbon 7 mounted on the supply shaft 8 is also rotated at a specific speed.

If the take-up shaft 9 is rotationally driven at a constant speed in Act 2, the roll of the ink ribbon 7 held by the supply shaft 8 is rotated in a particular direction (e.g., in the same direction as the conveying direction F of the label paper) at a substantially constant speed.

While the roll of the ink ribbon 7 is rotated about the axis of the supply shaft 8, the sensor unit 27b is activated to irradiate light toward an area of the roll of the ink ribbon 7 including the end portion of the hub 70 and receive the reflection light reflected from the end portion of the hub 70 (Act 3).

Based on the received reflection light, the determination unit of the CPU 21 determines the identification information of the roll of the ink ribbon 7. The received reflection light may be represented by the output signal waveform as shown in FIG. 5.

The method of reading the identification information of the target print medium 4 may be performed in the same manner as that of determining the identification information of the roll of the ink ribbon 7. Specifically, the target print medium 4 is conveyed (or drawn) to rotate the roll of the target print medium 4 mounted on the paper supporting shaft 3 (Act 2). While the roll of the target print medium 4 is rotated, the sensor unit 27a is activated to read the identification information of the target print medium 4 (Act 3).

Then, the determination unit of the CPU 21 decides whether the identification information is successfully determined (Act 4). If the identification information of the target print medium 4 and the ink ribbon 7 is determined (if “YES” in Act 4), the CPU 21 retrieves matching print condition information in the print condition table 16 (see FIG. 6) stored in the storage unit (e.g., the NVRAM) using the identification information determined by the determination unit (Act 5). Print conditions such as the thermal energy amount required to be applied to the thermal head 10 are determined based on the retrieved print condition information (Act 6).

Values of the thermal energy amounts required to be applied to the thermal head 10 to achieve an optimal print quality for respective combinations of respective ink ribbons 7 and respective target print media 4 may be stored in the print condition table 16 in advance. The values stored in the print condition table 16 may be obtained by practical experiments or the like. The CPU 21 changes the current supply time and the voltage potential pursuant to one of the values of the thermal energy amounts stored in the print condition table 16 so that a specified amount of thermal energy can be applied to the thermal head 10.

Then, the CPU 21 operates a display unit to display the identification information of the target print medium 4 and the ink ribbon 7 thus obtained and the thermal energy amount required to be applied to the thermal head 10. For example, the identification information and the thermal energy amount are displayed to read “Ink Ribbon: Ribbon a; Paper: Label Paper A; Thermal Energy Amount Required To Be Applied To Thermal Head: xxxx” (Act 7).

By operating the display unit to display the identification information and the print conditions (e.g., the thermal energy amount required to be applied to the thermal head 10), an operator can visually check the identification information of the roll of the target print medium 4 mounted to the paper supporting shaft 3 and the roll of the ink ribbon 7 mounted to the supply shaft 8.

After the identification information and the print conditions are displayed on the display unit (Act 7), the actual print conditions of the printer 1 are set based on the displayed print conditions (Act 8). If the setting of the print conditions is finished (if “YES” in Act 9), the CPU 21 performs an operation to wind back the rolls of the ink ribbon 7 and the target print medium 4 in the opposite direction to the conveying direction F (Act 10). Through the operation of Act 10, the ink ribbon 7 and the target print medium 4, which have been conveyed (i.e., unwound) in order to read the identification information of the rolls mounted on the roll supporting unit, can be rewound on the rolls. This helps prevent waste of the ink ribbon 7 and the target print medium 4.

Thereafter, the printer 1 waits for a print operation start command (Act 11). Upon receiving the print operation start command, the printer 1 begins to perform a print operation.

On the other hand, if the identification information is not determined in Act 4 (if “NO” in Act 4), the CPU 21 conveys back (i.e., rewind) the ink ribbon 7 in the opposite direction to the conveying direction F by synchronously rotating the first ribbon motor 35a and the second ribbon motor 35b and rotating the take-up shaft 9 and the supply shaft 8 (Act 12). This makes it possible to prevent waste of the ink ribbon 7. Additionally, the CPU 21 may also convey back the target print medium 4 in the opposite direction to the conveying direction F during the operation of Act 12.

Then, the CPU 21 waits until a reading request signal (requesting the CPU 21 to read again the identification information of the ink ribbon 7 or the target print medium 4) is inputted through the input unit (Act 13). If the reading request signal is inputted (if “YES” in Act 13), the CPU 21 directs the procedure to Act 2 where the roll is operated to be rotated. Then, the identification information reading operation is performed again by activating the sensor units 27a and 27b (Act 3). If a signal requesting the CPU 21 not to read the identification information again is inputted through the input unit (if “NO” in Act 13), the printer 1 receives print conditions from a host computer through the communication interface (I/F) 25. After the print conditions thus received are set (Act 14) as the actual print conditions of the printer 1, the printer 1 waits for a print operation start command (Act 11). Upon receiving the print operation start command, the printer 1 performs a print operation on the target print medium 4 with the thermal energy corresponding to one of the values stored in the storage unit.

With the printer 1 of the embodiment described above, the slits 140 are formed on the hub end portion of the roll of the ink ribbon 7 or the target print medium 4. The roll (of the ink ribbon 7 or the target print medium 4) whose identification information corresponds to the array of the slits 140 is loaded to the roll supporting unit. The roll is operated to rotate. The reflection type sensor used as the sensor unit 27a or 27b is operated to irradiate light toward the area of the roll having the slits 140 and receive the reflection light. The identification information of the roll loaded to the roll supporting unit is obtained based on the received reflection light. Based on the identification information, the print conditions can be set in the printer 1 by referring to the storage unit that stores in advance the thermal energy amounts required to be applied to the thermal head 10 to achieve an appropriate print density for any combination of specific ink ribbons 7 and specific target print media 4. This eliminates difficulties otherwise encountered in setting the print conditions when the printer 1 is in use. The print conditions stored in the storage unit are not limited to the ones corresponding to the combinations of ink ribbon 7 and target print medium 4. The storage unit may store the thermal energy amounts required to be applied to the thermal head 10 to achieve an appropriate print density in case of using a specific kind of target print media 4 or specific kind of ink ribbon 7.

In a printer of the related art, the thermal energy amounts required to be applied to the thermal head 10 to accomplish an appropriate print density are manually set depending on the kinds of ink ribbons or target print media. This requires a time-consuming setting operation. In the above embodiment of the present disclosure, however, the print conditions are set after automatically determining the identification information of the roll of the ink ribbon or the target print medium. This makes it possible to significantly reduce the setting operation time. In addition, there is no need to perform any cumbersome operation in setting the print conditions, which makes it possible to alleviate the burden borne by the operator.

Since the thermal energy amounts required to be applied need not be manually set depending on the kinds of ink ribbons or target print media, it is possible to prevent any erroneous setting which may be caused by an operator's inputting error.

With the printer of the above embodiment, the identification information of a new roll of an ink ribbon or a target print medium loaded to the paper supporting shaft can be read and the print conditions can be set by simply loading the roll onto the paper supporting shaft and detecting the slits of the hub end portion of the roll. This makes it easy to set the print conditions.

With the printer of the above embodiment, the identification information detected by the sensor units 27a and 27b is displayed on a display unit. This makes it possible to visually confirm the kind of roll attached to the roll supporting unit and the print conditions set in the printer.

While certain embodiments have been described, these embodiments have been presented by way of example only, and are not intended to limit the scope of the inventions. Indeed, the novel printer and roll described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

In the present embodiment, a plurality of cutout-shaped slits is formed in the hub end portion of a roll. Light is irradiated toward the slits and the reflection light reflected from the slits is received. The identification information of the roll is specified based on the light reception results. However, the intensity of the light reflected from the hub end portion can be changed by other members than the slits formed in the hub end portion. For example, a sheet-like member with black and white patterns may be bonded to the hub end portion so that the intensity of the light reflected from the hub end portion can be changed when light is irradiated from the sensor units toward the hub end portion.

As used in this application, entities for executing the operations can refer to a computer-related entity, either hardware, a combination of hardware and software, software, or software in execution. For example, an entity for executing an operation can be, but is not limited to being, a process running on a processor, a processor, an object, an executable, a thread of execution, a program, and a computer. By way of illustration, both an application running on an apparatus and the apparatus can be an entity. One or more entities can reside within a process and/or thread of execution and an entity can be localized on one apparatus and/or distributed between two or more apparatuses.

The program for realizing the functions can be recorded in the apparatus, can be downloaded through a network to the apparatus or can be installed in the apparatus from a computer readable storage medium storing the program therein. A form of the computer readable storage medium can be any form as long as the computer readable storage medium can store programs and is readable by the apparatus such as a disk type ROM and a solid-state computer storage media. The functions obtained by installation or download in advance in this way can be realized in cooperation with an OS (Operating System) in the apparatus.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A printer, comprising:
a roll supporting unit configured to rotatably support a roll including a hub having a light reflection changing member and a strip-shaped material wound around the hub;
a sensor unit configured to irradiate light toward the light reflection changing member and receive reflected light from the light reflection changing member;
a determination unit configured to determine identification information for identifying the roll based on the reflected light received by the sensor unit;
a control unit configured to set a print condition based on the identification information determined by the determination unit; and
a print unit configured to print on the strip-shaped material based on the print condition set by the control unit.

2. The printer of claim 1, wherein the light reflection changing member comprises slits provided on an end portion of the hub of the roll formed based on a particular pattern.

3. The printer of claim 1, further comprising:
a storage unit configured to store the identification information for identifying the roll and the print condition,
wherein the control unit is further configured to obtain the print condition from the storage unit based on the identification information.

4. The printer of claim 3, further comprising:
a display unit configured to display information on the roll,
wherein the display unit is configured to display the identification information determined by the determination unit.

5. A roll for use in a printer having a roll supporting unit rotatably supporting a roll, a sensor unit irradiating light and receiving reflected light, a determination unit determining identification information for identifying the roll based on the reflected light received by the sensor unit, and a print unit printing on a material based on a print condition associated with the identification information, the roll comprising:
a hub which is rotatably supported on the roll supporting unit and includes a light reflection changing member provided on an end portion of the hub to receive the light irradiated from the sensor and reflect the light; and
a strip-shaped material wound around the hub to be printed based on the print condition.

6. The roll of claim 5, wherein the light reflection changing member comprises slits provided on an end portion of the hub of the roll formed based on a particular pattern.

7. A method for use in a printer including a roll supporting unit configured to rotatably support a roll including a hub having a light reflection changing member and a strip-shaped material wound around the hub, the method comprising:
irradiating light toward the light reflection changing member;
receiving reflected light from the light reflection changing member;
determining identification information for identifying the roll based on the reflected light;
setting a print condition based on the identification information; and
printing on the strip-shaped material based on the print condition.

8. The method of claim 7, wherein the light reflection changing member comprises slits provided on the end portion of the hub of the roll formed based on a particular pattern.

9. The method of claim 7, further comprising:
storing the identification information of the roll and the print condition in a storage unit of the printer; and
obtaining the print condition from the storage unit based on the identification information.

10. The method of claim 7, further comprising:
displaying the identification information in a display unit of the printer.
